(19) United States
(12) Patent Application Publication
(10) Pub. No.: US 2025/0216760 A1
(43) Pub. Date: Jul. 3, 2025

(54) SCREEN MAGNIFYING DISPLAY DEVICE

(71) Applicant: Far Vision Technology Co., Ltd., Taichung City (TW)

(72) Inventor: Stephen CHEN, Taichung City (TW)

(21) Appl. No.: 18/800,741

(22) Filed: Aug. 12, 2024

(30) Foreign Application Priority Data
Jan. 2, 2024 (TW) 113100002

(51) Int. Cl. G03B 21/28; G03B 17/54; G03B 21/14

(52) U.S. Cl. CPC G03B 21/28; G03B 17/54; G03B 21/142; G03B 21/145

(57) ABSTRACT

A screen magnifying display device is provided and includes an upper shell, a lower shell, a connection mechanism and a support. A first reflector is mounted on the inner sider of the upper shell and receives an image of a display module below the upper shell. A second reflector is mounted on the inner sider of the lower shell, receives the reflection image projected by the first reflector, and reflects and forwardly projects the reflection image to form a projection image. The connection mechanism is connected to one end of the upper shell and one end of the lower shell, the first reflector and the second reflector are disposed at an included angle. The support is disposed on the outer side of the lower shell. The second reflector is constituted for reducing the image distortion of the first reflector.

### FIELD OF THE INVENTION

The present disclosure is related to an optical device and is particularly related to a screen magnifying display device configured to forwardly project an image below thereof.

### BACKGROUND OF THE INVENTION

Because of popularization of cell phones, tablets, books and toys, a rise of short-sightedness proportion in children is a problem which each country confronts. In addition to genetic factors, the main reason for the short-sightedness is long-term use of eyes at close distances.

Ophthalmologists usually suggest keeping 30 centimeters between a book and the eyes when the children read the book and write and keeping 60 centimeters between a computer and the eyes when the children use the computer, but the 30 centimeters and the 60 centimeters are not standards, and there is no need to keep 30 centimeters between the book and the eyes and to keep 60 centimeters between the computer and the eyes for eye health. Honestly, due to the limitations of the operation distances and a user does not clearly see the text and the patterns on the book and a screen when the foregoing distances are too long, the suggestion as stated by the ophthalmologists is generated. If the operation distances may not be limited, for example, when the user utilizes a mouse to manipulate the computer, the screen may be disposed farther than the book because the text and the patterns may be enlarged. In this way, no matter what the situation is reading the book or using the screen, the farther the visual distance is, the more beneficial it is for the eye health.

Shortening the time for seeing near objects indicates that the time of working hard must be reduced, and it may bring about a risk of deterioration in the academic performance of the children, but forbidding the children to play the cell phone exploits the spare time of the children, and there is an unrealistic difficulty; the selection which does not affect the academic performance and the spare time of the children is extending the visual distance between the book and the eyes when the children read the book and write. However, the distinguishable ability of the eyes would deteriorate, and eyes fatigue easily happens after the long extension of the visual distance unless the text and the image are enlarged. Moreover, the long visual distance may beyond the manipulation scope of hands, and the limitation of the visual distance when the children naturally read the book and write is about 40 centimeters. Hence, it is necessary to get assistance from new technologies to extend the visual distance.

TWM569860U has disclosed a screen magnifying display device. The screen magnifying display device includes a support, a display module, a first reflective sheet and a second reflective sheet, and at least one of the first reflective sheet and the second reflective sheet is a concave mirror. Hence, the aforementioned screen magnifying display device utilizes the imaging principle of the virtual images of the concave mirror to enlarge the image of the display module by several times and to form the enlarged image of the display module 2 at a position of which a distance is several times longer than an object distance. The display module is connected to an electronic product by an input interface and magnifies and displays the image stored in the interior of the electronic product to alleviate the eyes fatigue effectively. However, the foregoing optical path of forming virtual images limits an input image source to electronic data from data lines or memory cards, etc.

### SUMMARY OF THE INVENTION

In light of the aforementioned object, the present disclosure provides a screen magnifying display device including an upper shell, a lower shell, a connection mechanism and a support. A first reflector is mounted on the inner sider of the upper shell and receives an image of a display module below the upper shell. A second reflector is mounted on the inner sider of the lower shell, receives the reflection image projected by the first reflector, and reflects and forwardly projects the reflection image to form a projection image. The connection mechanism is connected to one end of the upper shell and one end of the lower shell, the first reflector and the second reflector are disposed at an included angle so that the projection direction of the projection image intersects the projection direction of the image of the display module. The support is disposed on the outer side of the lower shell. The second reflector is constituted for reducing the image distortion of the first reflector.

Preferably, the first reflector is a concave mirror or a freeform mirror, and the second reflector is one of the concave mirror, a convex mirror and the freeform mirror.

Preferably, the connection mechanism is a first axle mechanism, and the first axle mechanism includes an axle, a flipping element with a block, and a location base with an arc-shape guide groove. The flipping element and the location base are respectively connected to the upper shell and the lower shell, and the axle is encased by and connected to the flipping element and the location base, and the arc-shape guide groove accommodates the block.

Preferably, the range of the included angle is between 50° and 70°.

Preferably, the screen magnifying display device further includes a lower base. The lower base is formed by protruding forwardly from one side of the lower shell far away from the connection mechanism, and the upper surface of the lower base is configured to mount the display module.

Preferably, the screen magnifying display device further includes a hidden camera. The hidden camera is disposed behind the second reflector, and the facing direction of the hidden camera is the same as the projection direction of the projection image.

Preferably, the screen magnifying display device further includes a camera. The camera is disposed on one side of the upper shell far away from the connection mechanism and faces downwardly and obtains an image of an area on a lower side of the lower shell or obtains an image of an area both below and in front of the lower shell.

Preferably, the screen magnifying display device further includes a circuit board. The circuit board is mounted on at least one of the upper shell and the lower shell and is electrically connected to the display module and at least one or a combination of a speaker, a microphone, a camera, a hidden camera, a transmission unit and an input interface.

Preferably, the circuit board further includes a processor configured to fix the partial distortion of the projection image.

Preferably, the screen magnifying display device further includes a second axle mechanism, and the support is connected to the lower shell by the second axle mechanism.

### THE DRAWINGS

FIG. 1 is a view diagram of an embodied aspect of a screen magnifying display device.

FIG. 2 is another view diagram of the screen magnifying display device of FIG. 1.

FIG. 3 is the cross section view diagram of the screen magnifying display device of FIG. 1.

FIG. 4 is an optical path schematic diagram of a screen magnifying display device.

FIG. 5 is an optical path schematic diagrams of generating optical distortion by a first reflector.

FIG. 6 is an optical path schematic diagrams of generating optical distortion by a second reflector.

FIG. 7 is an optical path schematic diagram of correcting optical distortion between a first reflector and a second reflector.

FIG. 8 is a schematic diagram of an axle mechanism of a screen magnifying display device.

FIG. 9 is a cross section view diagram of an axle mechanism of a screen magnifying display device.

FIG. 10 is a block diagram of electronic components included in a screen magnifying display device.

### DETAILED DESCRIPTION

In order to easily understand the relative position of each component, the following paragraphs would be described based on the front (i.e., the positive direction of Y-axis as shown in figures) defined by the projection direction of the light of the second reflector. The space formed by the included angle of a first reflector and a second reflector is defined as the interior of a screen magnifying display device, and the outside of the space formed by the included angle of the first reflector and the second reflector is defined as the exterior of the screen magnifying display device. For example, when the screen magnifying display device is used, a viewer is located on the front of the second reflector, and the expected magnifying image would be seen on the rear of the screen magnifying display device.

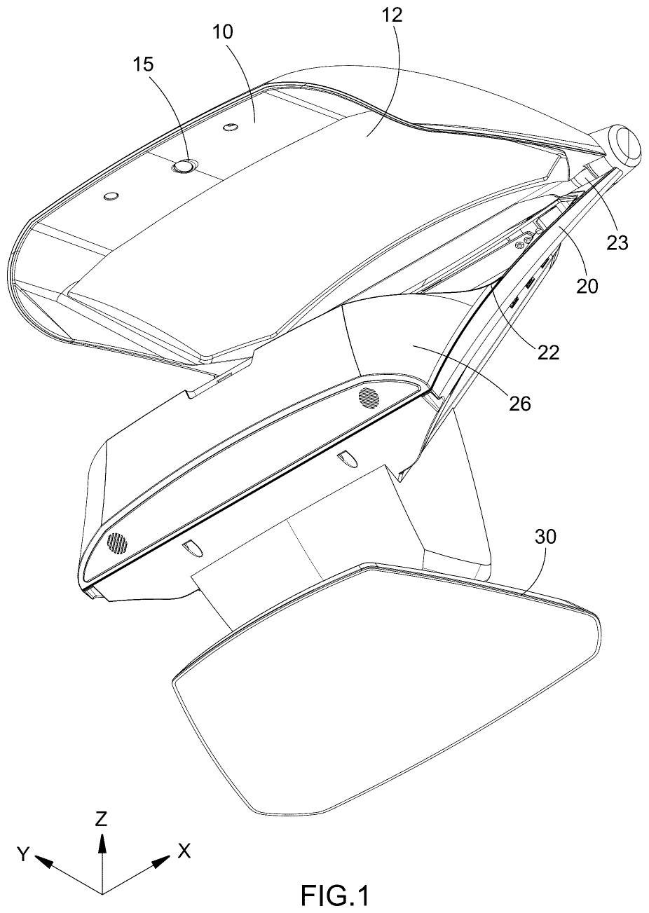

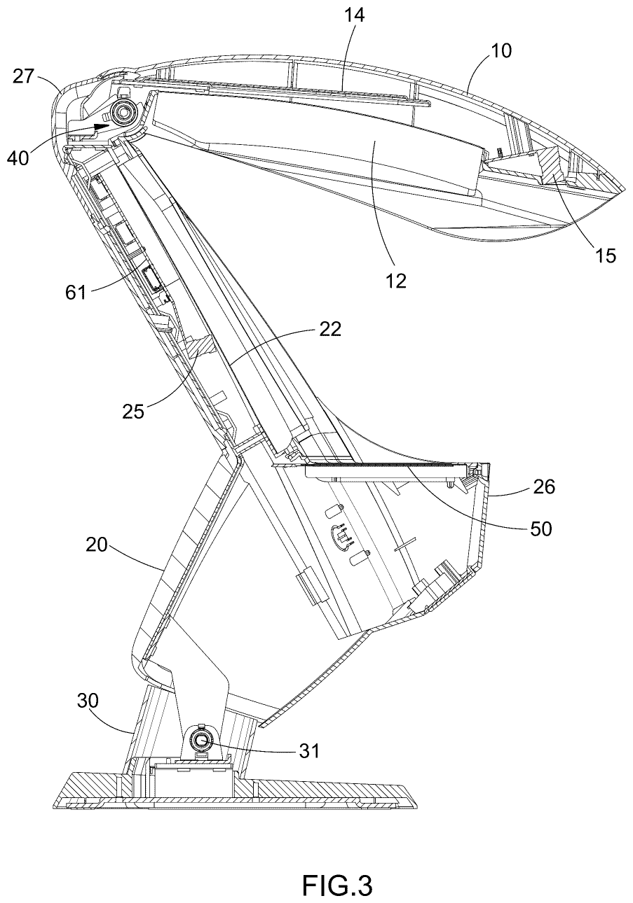

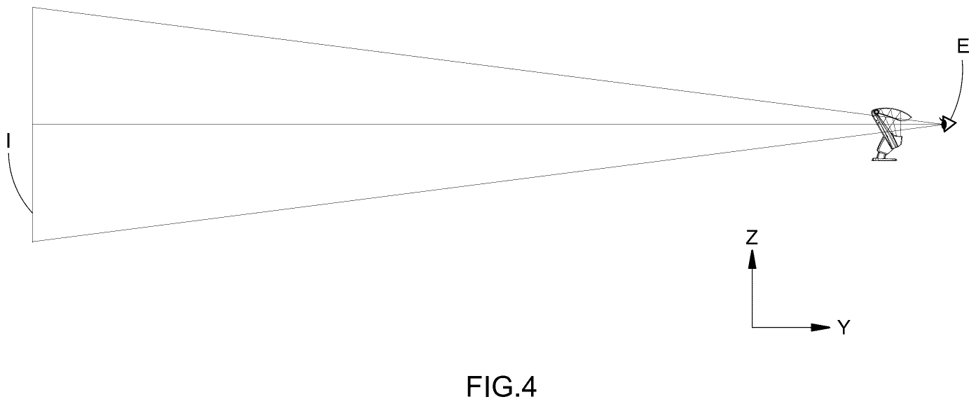

Please refer to FIG. 1 to FIG. 4 which depict the screen magnifying display device. The screen magnifying display device includes an upper shell 10, a lower shell 20, a connection mechanism and a support 30. A first reflector 12 is mounted on the inner sider of the upper shell 10, and a second reflector 22 is mounted on the inner sider of the lower shell 20, and the connection mechanism is connected to one end of the upper shell 10 and one end of the lower shell 20 so that the first reflector 12 and the second reflector 22 are disposed at an included angle of which the range is between 50° and 70°.

The support 30 is disposed on the outer side of the lower shell 20, and the optical path formed between the upper shell 10 and the lower shell 20 is built at a preset height. The first reflector 12 receives an image of a display module 50 below thereof, and the second reflector 22 receives the reflection image projected by the first reflector 12 and then reflects and forwardly projects the reflection image into the eyes E to form a projection image I. At this time, the projection direction of the projection image I intersects the projection direction of the image displayed by the display module 50. Thus, for the viewer, the image of the display module 50 would be located on the rear of the lower shell 20 to form the projection image I.

The combined optical path formed by the first reflector 12 and the second reflector 22 is configured to magnify the image of the display module 50 and to extend the image distance of the display module 50. Specifically, the first reflector 12 is a concave mirror or a freeform mirror, and the second reflector 22 is one of the concave mirror, a convex mirror and the freeform mirror.

If the concave mirrors are adopted, distortion would be generated on the image due to off-axis aberrations when the concave mirrors are used to magnify the image and results in image warping and image deformations, and the degree of the distortion is proportional to the cube of the vertical height from an image point to an optical axis. Hence, the concave mirrors may be designed to cancel out most of the image warping and the image deformations of the positive distortion and the negative distortion each other to reduce the image warping and the image deformations. In other words, the second reflector 22 may be further built to reduce the image distortion of the first reflector 12, or the first reflector 12 and the second reflector 22 may respectively correct one part of the optical distortion so that the display module 50 has the better image equality in the final combined optical path, and the viewers may not change their sitting postures to achieve the best angle of view and the comfort of reading.

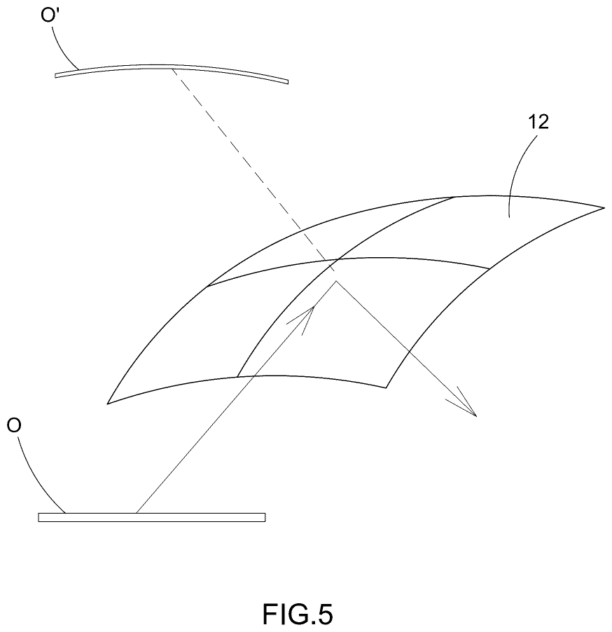

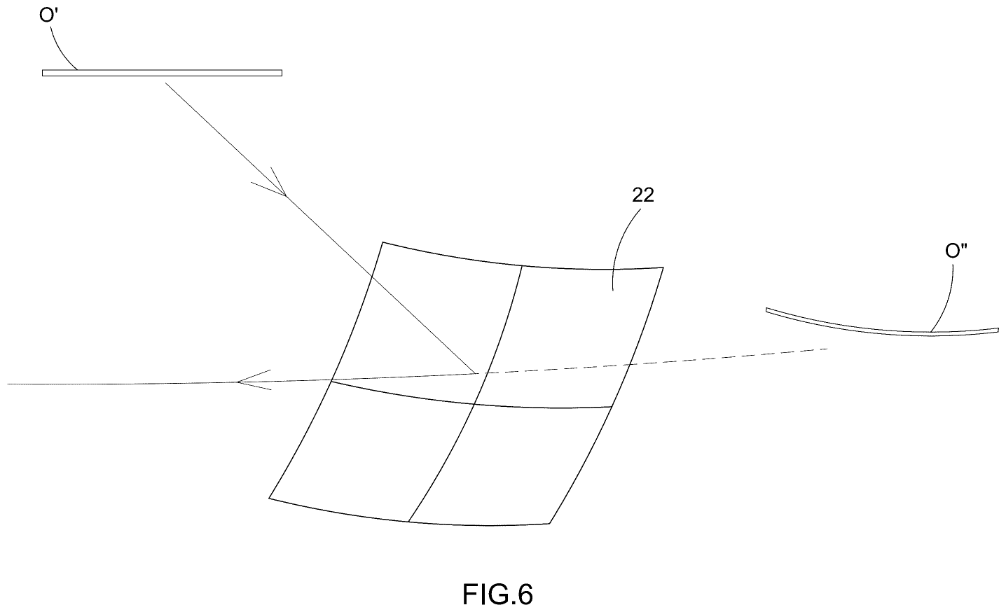

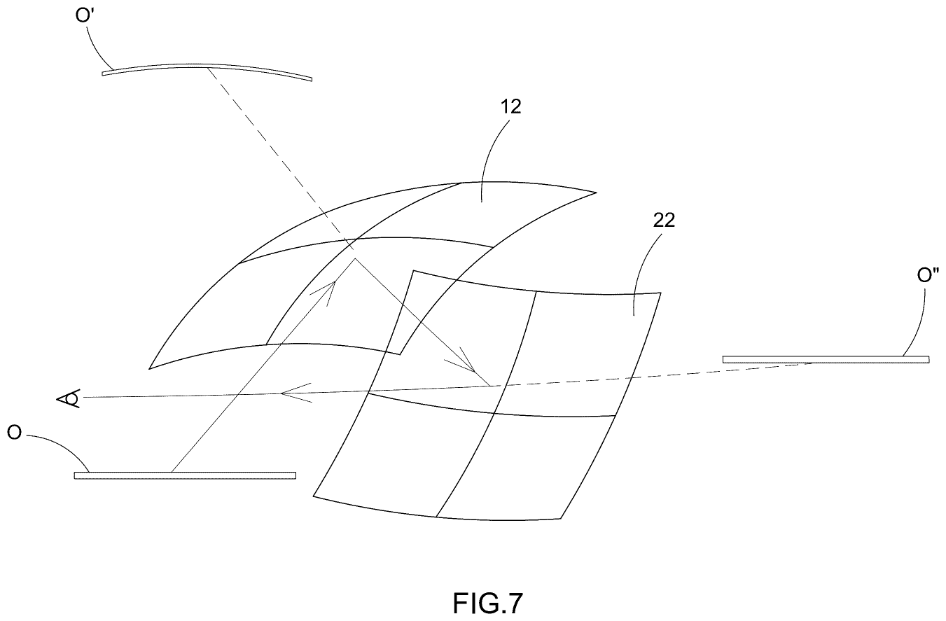

Please refer to FIG. 5 and FIG. 7, which are one type of the correction method for the optical distortion. In this set of images, the reflection direction of the actual light is shown by a solid line, and the image distance of the virtual image on the rear of the reflector is shown by a dotted line. Please refer to FIG. 5 and if the object O is a straight line, the object on the virtual image O′ formed on the first reflector 12 would be displayed as curved downwardly. Please refer to FIG. 6 and if the object O of the image O′ to project on the second reflector 22 is displayed as the straight line, the object on the image O″ formed on the second reflector 22 from image O′ would be displayed as curved upwardly. Please refer to FIG. 7, and by integrating the optical property of the first reflector 12 with the optical property of the second reflector 22, the object on the virtual image O″ would be displayed as curved upwardly after the second reflector 22 reflects the virtual image O′ of the first reflector 12 where the object is displayed as curved downwardly, and the negative distortion of the first reflector 12 and the positive distortion of the second reflector 22 be cancelled out each other by adjusting the curvatures of the first reflector 12 and the second reflector 22 so that the object O on the image projected into the eyes is still displayed as the straight line. In details, the object O depicted at FIG. 7 is the image display on the display module 50.

In the present embodiment, the support 30 is connected to the lower shell 20 by the second axle mechanism 31. The upper shell 10 and the lower shell 20 is configured to define the entire optical path, and the lower shell 20 may swing relative to the support 30 and be used to slightly adjust the projection angle of the entire optical path so that the user may easily obtain the optimized angle of view.

In the present embodiment, in a situation that the lower shell 20 has a lower base 26 formed by protruding forwardly, there may be another camera 15 disposed on the upper shell 10 and being adjacent to the shell boundary of the upper shell 10, and the camera 15 is configured to capture the scene in an area below the lower side of the lower shell 20 or the scene in the area below and in front of the lower shell 20. The object to display such as a book and a smart phone would be placed within the field of view of the camera 15, and the display module 50 displays the image of the object O, and the expected magnifying image with the object O would be seen on the rear of the screen magnifying display device.

In the present embodiment, the lower base 26 is formed by protruding forwardly from one side of the lower shell 20 far away from a first axle mechanism 40, and the upper surface of the lower base 26 is parallel to XY plane, and the lower base 26 is configured to mount the display module 50. When the display module 50 is mounted on the lower base 26, the image projection surface of the display module 50 is parallel to XY plane. The second reflector 22 is backwardly slanted relative to the image projection surface of the display module 50.

In the present embodiment, the connection mechanism comprises the first axle mechanism 40. The upper shell 10 is allowed to flip relative to the lower shell 20 by the first axle mechanism 40, and entirely covers the surface of the lower shell 20 to form the storage state of the foldable screen magnifying display device. Correspondingly, the foldable screen magnifying display device is in the unfolding state when the upper shell 10 and lower shell 20 forms the preset optical path. When the upper shell 10 is in the storage state, the inner side of the upper shell 10 and the inner side of the lower shell 20 are totally shaded, and thus, the front of the second reflector 22 and the display module 50 are all totally shaded so that the interior electrical components are protected to reduce the entire volume of the foldable screen magnifying display device.

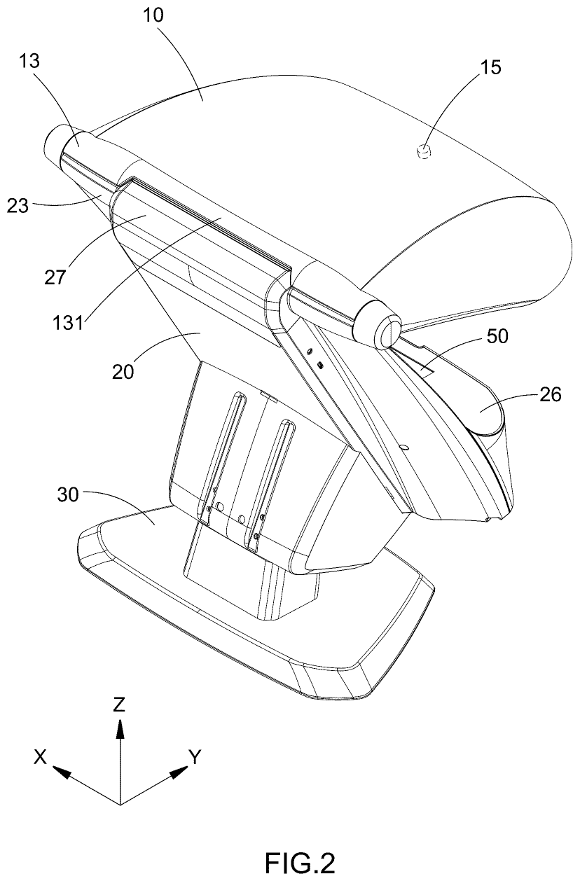

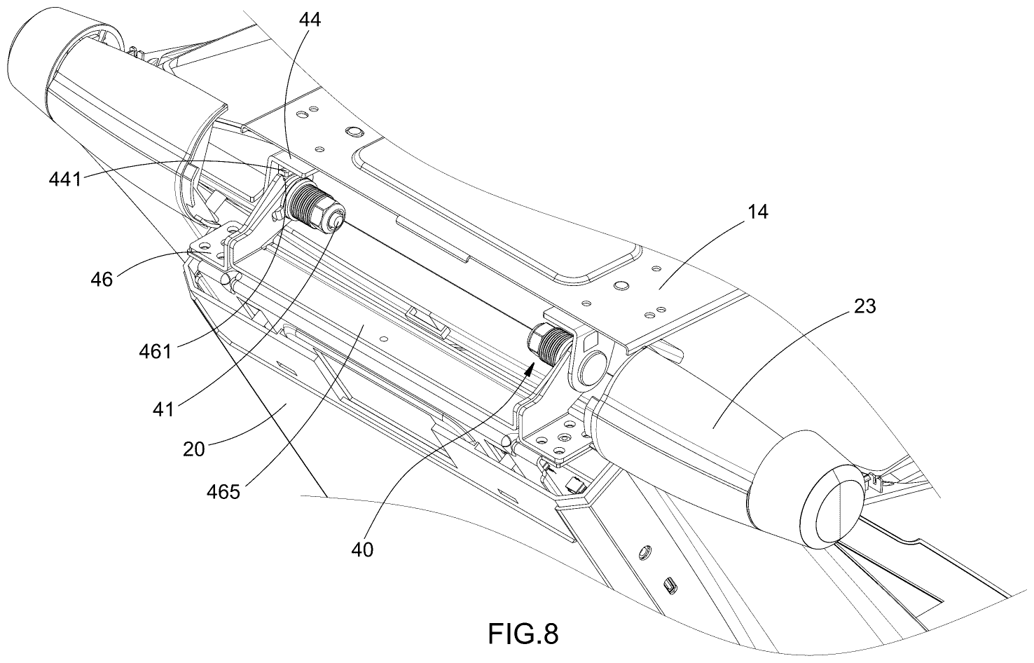

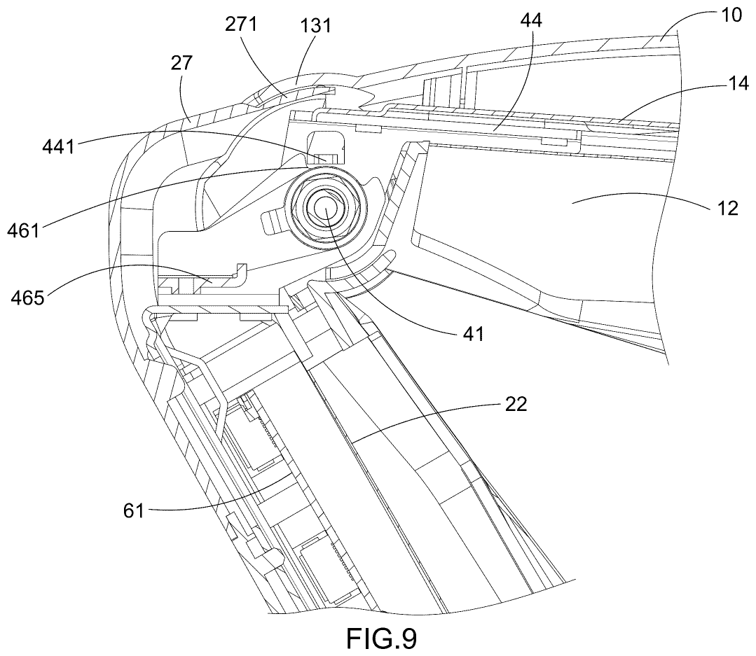

Please refer to FIG. 1, FIG. 2, FIG. 8 and FIG. 9, which depict the connection mechanism comprising the first axle mechanism 40. In the present embodiment, axle housings 23 is one part of the lower shell 20 and are located on two ends of one side of the lower shell 20. The axle housings 13 are also formed on two ends of one side of the lower shell 20 and spans two ends of the axle housing 23, and the two axle housings 13 are connected by a middle shell and cover one part of the surfaces of the axle housings 23. When the upper shell 10 rotates, the surfaces of the axle housings 23 may support the two axle housings 13, i.e., the surface of the axle housings 23 serve as one part of the rotary axes of the axle housings 13.

If the two axle housings 13 and the axle housings 23 are merely mounted, the accommodation cavity accommodating the first axle mechanism 40 would be exposed on the rear of the connection mechanism. Hence, the connection mechanism further has an axle cover 27, the two ends of the axle cover 27 are connected to the ends of the two axle housings 13 and the end of the axle housing 23 which are adjacent to the axle cover 27, and the axle cover 27 is configured to seal the accommodation cavity accommodating the first axle mechanism 40. In addition, a protruded edge 271 extends forwardly from the axle cover 27 and is located on the lower side of the upper shell 10, and when the upper shell 10 rotates, the surface of the protruded edge 271 may support the rear end 131 of the middle shell of the axle housing 13, i.e., the surface of the protruded edge 271 serves as one part of the rotary axes of the axle housings 13. In addition, the protruded edge 271 and one part of the upper shell 10 are at least connected or overlap to avoid exposing the first axle mechanism 40 outside.

The first axle mechanism 40 is disposed in pairs, and each pair of the first axle mechanism 40 includes an axle 41, a flipping element 44 and a location base 46. The axle 41 is encased by and connected to the flipping element 44 and the location base 46. The location base 46 has an arc-shape guide groove 461, and the flipping element 44 has a block 441 formed by protruding along the axial direction of the axle 41, and the arc-shape guide groove 461 accommodates the block 441.

The location base 46 is fixed on lower shell 20, and the flipping element 44 rotates relative to the location base 46 by the axle 41, and one part of the flipping element 44 is positioned on the flipping flat 14 of the upper shell 10. Hence, the block 441 and the upper shell 10 rotate synchronously, and the arc-shape guide groove 461 limits the degree of swinging of the flipping element 44 based on the axle 41 as the rotary axe. The storage state and the unfolding state are built.

In addition, the first axle mechanism 40 further includes a connecting board 465, and the two ends of the connecting board 465 are respectively positioned on the location base 46 of one pair of the first axle mechanism 40 to increase the stability of the first axle mechanism 40 to support the upper shell 10. Furthermore, the connecting board 465 may be positioned on the lower shell 20 at the same time.

In the other embodiments, the first axle mechanism 40 may further include a torsion spring, and the two ends of the torsion spring are respectively positioned on the location base of the lower shell 20 and the flipping element of the upper shell 10, and the upper shell 10 is flipped upwardly by applying force. In addition, the first axle mechanism 40 may further include a damper so that the upper shell 10 may slowly and steadily flip.

In the other embodiments, the surface of the lower shell 20 may be recessed inwardly to form a handheld groove (not shown in Figures) which is provided to hold and to remove the screen magnifying display device. The surface adjacent to the handheld groove may be provided with an anti-slip surface (e.g. anti-slip bumps).

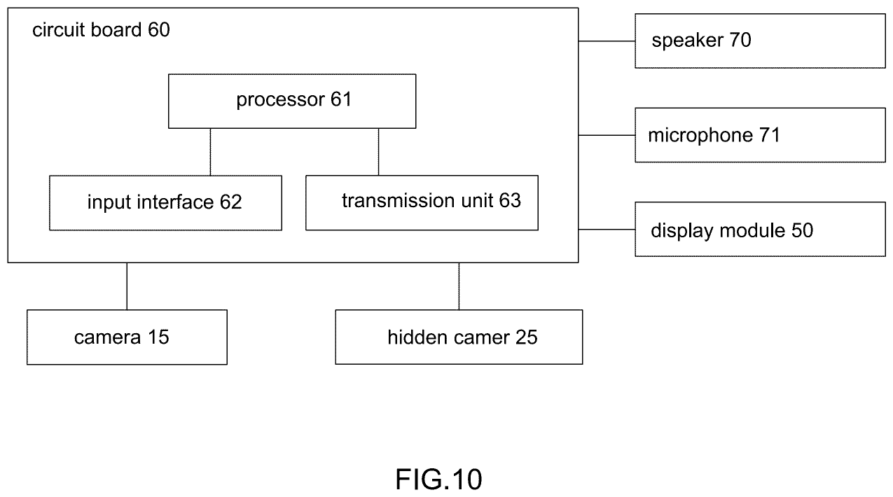

Please refer to FIG. 1, FIG. 2 and FIG. 10. In order to expand the application scope of the screen magnifying display device, the screen magnifying display device includes a circuit board 60 located on at least one of the upper shell 10 and the lower shell 20, and the circuit board 60 includes a processor 61, and the processor 61 is electrically connected to a combination of at least one, at least two, or more than two of a speaker 70, a microphone 71, a camera 15, a hidden camera 25, a transmission unit 63 and an input interface 62. The number and the type of the electronic components on the interior of the screen magnifying display device depends on the preset application scenes thereof.

The processor 61 includes an image signal processing chip. The image signal processing chip is configured to process the image ratio of the reflection image of the first reflector 12 and/or the second reflector 22, the other distortion between the first reflector 12 and the second reflector 22 which can not be corrected, the local distortion or the other possible distortion to adjust the image and ensures again that the projection image projected into the eyes is appropriate and displays the adjusted image on the display module 50.

The speaker 70 is electrically connected to the processor 61 and is configured to playback the audio signals of the image and pure audio signals from an external input. The microphone 71 is electrically connected to the processor 61 and is configured to receive sounds such as the voice of the user.

The functions of the camera 15 has been described and would not be repeated again. The lower shell 20 further includes a hidden camera 25. The hidden camera 25 is electrically connected to the circuit board 60 and is disposed on the rear of the second reflector 22. The facing direction of the hidden camera 25 is the same as the projection direction of the reflection image (i.e., the front). The hidden camera 25 camera is configured to shoot the front of the screen magnifying display device, for example, to capture the image of the user. Serving as monitoring, the hidden camera 25 may transmit the image by the transmission unit 63. Thus, when an easily distracted child uses the screen magnifying display device to watch a video, parents may obtain the information of the video from the image shot by the hidden camera 25. When the child leaves the front of the screen magnifying display device, the parents may know the leaving of the child.

The transmission unit 63 is electrically connected to the processor 61, and performs wireless transmission by, for example, Bluetooth, WIFI or Internet to receive the image or the audio signals from the external input. The foregoing image transmitted by the processor 61 (or undergone pre-processing at the same time) serves as the input image of the display module 50.

The input interface 62 may be the slots for HDMI, DVI, Display Port, D-SUB, USB slot, SD card, etc., and receive the image or the audio signals from the external input and displays the image on the display module 50. The foregoing input interface 62 or the transmission unit 63 may be changed to operate by the wired transmission or the wireless transmission or may be the same unit.

As described above, the screen magnifying display device provided by the present disclosure utilizes the imaging principle of the virtual images of the concave mirror to magnify the image with the object by several times and the magnified image with the object is formed at the distance longer than the object distance by several times so that the eyes of the user may see the magnified image at the visual distance beyond 7 meters and the user would not have the short-sightedness due to the long-term use of eyes at the close distances. In addition, based on the design of the optical components provided by the present disclosure, the image distortion of the projection image may be reduced and removed.

### LIST OF REFERENCE SIGNS

10: upper shell
12: first reflector
13, 23: axle housing
131: rear end
14: flipping flat
15: camera
20: lower shell
22: second reflector
25: hidden camera
26: lower base
27: axle cover
271: protruded edge
30: support
31: second axle mechanism
40: first axle mechanism
41: axle
441: block
44: flipping element
46: location base
461: arc-shape guide groove
465: connecting board
50: display module
60: circuit board
61: processor
62: input interface
63: transmission unit
70: speaker
71: microphone
O: object
O′, O″: virtual image
E: eyes
I: projection image

1. A screen magnifying display device comprising:
an upper shell;
a first reflector mounted on an inner sider of the upper shell and receiving an image of a display module below the upper shell;
a lower shell;
a second reflector mounted on an inner sider of the lower shell, receiving a reflection image projected by the first reflector, and reflecting and forwardly projecting the reflection image to form a projection image;
a connection mechanism connected to an end of the upper shell and an end of the lower shell, wherein the first reflector and the second reflector are disposed at an included angle so that a projection direction of the projection image intersects a projection direction of the image of the display module; and
a support disposed on an outer side of the lower shell;
wherein the second reflector is constituted for reducing image distortion of the first reflector.

2. The screen magnifying display device according to claim 1, wherein the first reflector is a concave mirror or a freeform mirror, and the second reflector is one of the concave mirror, a convex mirror and the freeform mirror.

3. The screen magnifying display device according to claim 1, wherein the connection mechanism comprises a first axle mechanism, and the first axle mechanism comprises an axle, a flipping element with a block, and a location base with an arc-shape guide groove, and the flipping element and the location base are respectively connected to the upper shell and the lower shell, and the axle is encased by and connected to the flipping element and the location base, and the arc-shape guide groove accommodates the block.

4. The screen magnifying display device according to claim 1, wherein a range of the included angle is between 50° and 70°.

5. The screen magnifying display device according to claim 1, further comprising a lower base, and the lower base is formed by protruding forwardly from a side of the lower shell far away from the connection mechanism, and an upper surface of the lower base is configured to mount the display module.

6. The screen magnifying display device according to claim 1, further comprising a hidden camera disposed behind the second reflector, and a facing direction of the hidden camera is the same as the projection direction of the projection image.

7. The screen magnifying display device according to claim 1, further comprising a camera disposed on a side of the upper shell far away from the connection mechanism, and the camera faces downwardly and obtains an image of an area on a lower side of the lower shell or obtains an image of an area both below and in front of the lower shell.

8. The screen magnifying display device according to claim 1, further comprising a circuit board mounted on at least one of the upper shell and the lower shell, and the circuit board is electrically connected to the display module and at least one or a combination of a speaker, a microphone, a camera, a hidden camera, a transmission unit and an input interface.

9. The screen magnifying display device according to claim 8, wherein the circuit board further comprises a processor configured to fix partial distortion of the projection image.

10. The screen magnifying display device according to claim 1, further comprising a second axle mechanism, and the support is connected to the lower shell by the second axle mechanism.
